(19) United States
(12) Patent Application Publication
(10) Pub. No.: US 2016/0033993 A1
(43) Pub. Date: Feb. 4, 2016

(54) Wearable Device And Electric Storage Equipment

(71) Applicant: Lenovo (Beijing) Co., Ltd., Beijing (CN)

(72) Inventor: Dayong GAN, Beijing (CN)

(73) Assignee: Lenovo (Beijing) Co., Ltd., Beijing (CN)

(21) Appl. No.: 14/640,169

(22) Filed: Mar. 6, 2015

(30) Foreign Application Priority Data
Aug. 4, 2014 (CN) 201410379656.9

(51) Int. Cl. G06F 1/16

(52) U.S. Cl. CPC G06F 1/163

(57) ABSTRACT

A wearable device and an electric storage equipment are provided according to the present application. The wearable device includes a transparent window, a frame, a controller, and a sensor. A parameter of the wearing state of the wearable device can be acquired by the sensor, and a state of the frame can be controlled by the controller according to the parameter. When the wearable device is worn by the user, the frame is controlled to be in a first state to allow the frame to be invisible, and when the wearable device is not worn by the user, the frame is controlled to be in a second state to allow the frame to be visible or identifiable. The electric storage equipment may allow a transmittance of a set area to be switchable, thus, articles inside a casing can be observed without opening the door.

This application claims the benefit of priority to Chinese Patent Application No. 201410379656.9 titled “WEARABLE DEVICE AND ELECTRIC STORAGE EQUIPMENT”, filed with the Chinese State Intellectual Property Office on Aug. 4, 2014, the entire disclosure of which is incorporated herein by reference.

### TECHNICAL FIELD

The present application relates to the technical field of electric equipment, and particularly to a wearable device and an electric storage equipment.

### BACKGROUND

With the development of the technology and science, various wearable devices and electric storage equipments have been widely used in our work and daily life, and provide great convenience to our work and life.

For ensuring the operational safety and service life of the wearable devices and the electric storage equipments, or installing or placing the electric equipments more conveniently, the transparent property of the conventional frame and casing cannot be changed.

### SUMMARY

A wearable device and an electric storage equipment are provided according to the present application, in which both of a frame of the wearable device and a casing of the electric storage equipment is switchable between two transmittance states.

The following technical solutions are provided according to the present application.

A wearable device is provided, which includes a frame, configured to fix the wearable device with respect to a user in a case that the wearable device is worn by the user, and the frame has a first state having a first transparency and a second state having a second transparency lower than the first transparency; a sensor configured to sense a wearing state of the wearable device to generate a wearing state sensing parameter; and a controller, which is connected to the sensor and is configured to control the frame to be in the first state or in the second state according to the wearing state sensing parameter.

A wearable device is further provided according to the present application. The wearable device includes: a transparent window; and a frame, which is configured to fix the transparent window and configured to fix the wearable device with respect to a user in a case that the wearable device is worn by the user, and the frame has a first state and a second state, the frame in the first state is configured to have a transparency same as a transparency of the transparent window, to allow the frame to be invisible, and the frame in the second state is configured to have a transparency lower than the transparency of the transparent window, to allow the frame to be visible or identifiable.

An electric storage equipment is further provided according to the present application. The electric storage equipment includes a set area with an adjustable transmittance, and the set area has a first state having a first transmittance and a second state having a second transmittance different from the first transmittance; a sensor, which is configured to sense whether the set area of the electric storage equipment is triggered, to generate a sensing parameter; and a controller, which is connected to the sensor and configured to switch the state of the set area according to the sensing parameter to adjust visibility of a space at least partially shielded by the set area.

### BRIEF DESCRIPTION OF THE DRAWINGS

In order to more clearly illustrate the embodiments of the present application or the technical solution in the conventional technology, drawings referred to describe the embodiments or the conventional technology will be briefly described hereinafter. Apparently, the drawings in the following description are only a few of embodiments of the present application, and for the person skilled in the art, other drawings may be obtained based on these drawings without any creative efforts.

FIG. 1 is a structural schematic view of an adjustable transmittance component in a first state according to a first embodiment of the present application.

FIG. 2 is a structural schematic view of the adjustable transmittance component in a second state according to the first embodiment of the present application.

FIG. 3 is a structural schematic view of a wearable device according to a second embodiment of the present application.

FIG. 4 is a structural schematic view of another wearable device according to the second embodiment of the present application.

FIG. 5 is a structural schematic view of another wearable device according to the second embodiment of the present application.

FIG. 6 is a structural schematic view of an electric storage equipment according to a fourth embodiment of the present application.

### DETAILED DESCRIPTION

The technical solutions in the embodiments of the present application will be described clearly and completely hereinafter in conjunction with the drawings in the embodiments of the present application. Apparently, the described embodiments are only a few of the embodiments of the present application, rather than all embodiments. All of other embodiments, made by the person skilled in the art without any creative efforts based on the embodiments in the present application, fall into the scope of the present application.

### First Embodiment

A wearable device is provided according to the present embodiment. The wearable device includes: a transparent window, a frame, a sensor, and a controller.

The transparent window may be a transparent sheet, such as a transparent glass sheet or a transparent plastic sheet, only for observing objects at another side of the transparent sheet from one side thereof; the transparent window may also be a transparent screen, which may be provided for observing objects at another side of the transparent screen from one side thereof, and also for displaying set information.

The frame is provided for fixing the transparent window and to fix the wearable device with respect to a user when the user wears the wearable device. The frame has a first state and a second state, the frame in the first state has a transparency same as the transparency of the transparent window, and the frame in the second state has a transparency lower than the transparency of the transparent window.

The frame may fix the wearable device with respect to the user, thus, the wearable device may be worn on the body of the user, for example may be wore on the head, the neck, the waist, the arm, or the leg.

The sensor is configured to sense a wearing state of the wearable device to generate a wearing state sensing parameter. When the wearable device is worn or not worn, the sensor may generate different wearing state sensing parameters. The sensor may be one of a pressure sensor, a temperature sensor, a pulse sensor, and a contact sensing electrode.

The controller is connected to the sensor and is configured to determine whether the wearable device is worn by the user according to the wearing state sensing parameter. If the controller determines, according to the wearing state sensing parameter, that the wearable device is fixed with respect to the user through the frame, the controller controls the frame to be in the first state, to allow the transparency of the frame to be same with the transparency of the transparent window, thus, the frame is invisible with respect to the transparent window when the wearable device is worn by the user. If the controller determines that the wearable device is not worn by the user according to the wearing state sensing parameter, the controller controls the frame to be in the second state, to allow the transparency of the frame to be lower than the transparency of the transparent window, thus, the frame is visible or identifiable with respect to the transparent window when the wearable device is not worn by the user, which facilitates locating the wearable device.

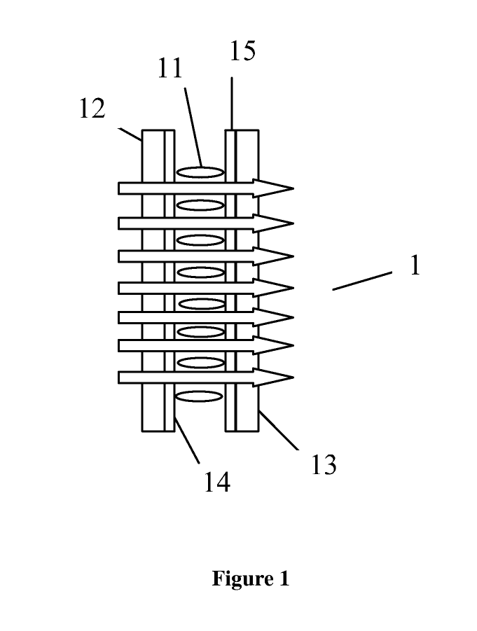

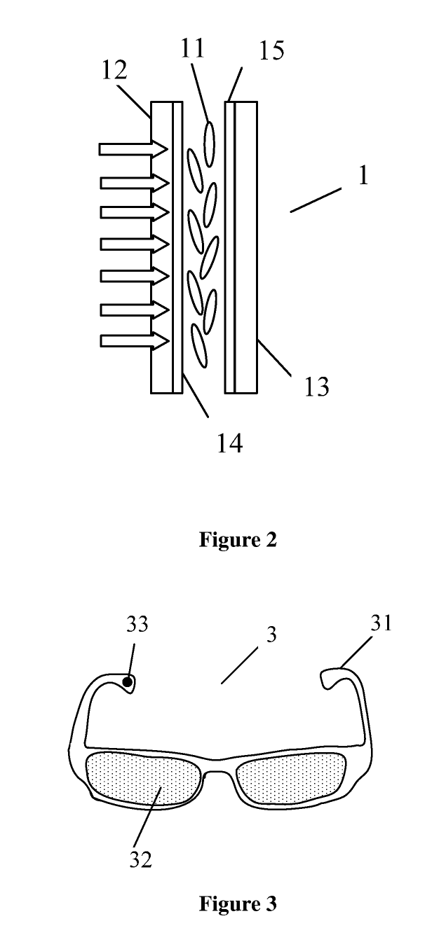

Reference is made to FIG. 1 and FIG. 2. The frame is an adjustable transmittance component 1. The adjustable transmittance component 1 includes a media layer 11. The controller is configured to vary the direction of M molecules of the media layer 11, and the ellipses in FIG. 1 and FIG. 2 are used to indicate the schematic structures of the M molecules. As shown in FIG. 1, the M molecules are controlled by the controller to be arranged in a first direction to form a light passage, thereby allowing the frame to be in the first state. As shown in FIG. 2, the M molecules are controlled by the controller to be arranged in a second direction different from the first direction, to shut off the light passage, thereby allowing the frame to be in the second state. The arrows in FIG. 1 and FIG. 2 indicate the direction of the light beam.

When the wearable device is fixed by the frame with respect to the user, the wearable device is in the first state, and a first beam is transmitted to the skin of the user from an outer side of the frame through a first light passage of the light passage. The first beam is scattered diffusely by the skin of the user to form a second light beam, and the second light beam is transmitted to the outer side of the frame from an inner side of the frame through a second light passage of the light passage. Due to the diffuse reflection, the second light passage and the first light passage may be the same light passages or different light passages. The outer side herein refers to a side of the wearable device that is away from the user when the wearable device is worn by the user, and the inner side herein refers to a side of the wearable device that is facing the user when the wearable device is worn by the user.

The adjustable transmittance component further includes a first transparent polar plate and a second transparent polar plate which are arranged opposite to each other. The media layer 11 is arranged between the first transparent polar plate and the second transparent polar plate. The media layer 11 may be a liquid crystal layer. The first transparent polar plate includes a first transparent base plate 12 and a first transparent electrode layer 14. The second transparent polar plate includes a second transparent base plate 13 and a second transparent electrode layer 15. The controller is configured to vary the direction of the M molecules of the media layer by controlling the voltage between the first transparent electrode layer 14 and the second transparent electrode layer 15, and to allow the frame to be in the first state when the M molecules are arranged in the first direction to form the light passage, and allow the frame to be in the second state when the M molecules are arranged in the second direction, which is different from the first direction, to shut off the light passage.

The first base plate and the second base plate may both be made of a flexible transparent base plate, to allow the frame to be flexible.

The wearable device according to the present embodiment further includes a power supply. The controller is connected to the power supply. The transparent window and the frame are defined as a first integral device. The power supply is an independent structural component separably connected to the first integral device; the sensor is an independent structural component separably connected to the first integral device; and the controller is an independent structural component separably connected to the first integral device.

The first integral device is provided to be worn at a predetermined position on the user, thus by arranging the power supply, the controller and the sensor independently with respect to the first integral device, the transparency of the first integral device will not be affected by the power supply, the controller and the sensor when the frame is in the first state, thereby making the first integral device have a uniform transparency. The controller may control the frame to switch state via a wireless driving signal. Or, the controller may provide a driving signal to the frame through a control wire to control the frame to switch state, and in this case, the entire wearable device can be invisible for a viewer as long as the control wire is arranged on the user wearing the wearable device at a position which is out of sight of the viewer.

The power supply, the controller and the sensor form a second integral device. The second integral device is an independent structural component separably connected to the first integral device. By integrating the power supply, the controller and the sensor, the integrated level of the wearable device is improved and the volume of the entire wearable device is reduced. The second integral device can be made into an ornament, which may be worn on the body of the user at a position different from the wearing position of the first integral device, for example, the second integral device can be made into a necklace to be worn on the neck of the user, or a bracelet or a ring to be worn on the hand of the user at a corresponding position, thereby separating the second integral device from the first integral device and allowing the first integral device to be invisible when being worn.

The sensor may be a transparent sensing electrode, which can be formed on the frame at a position where the frame directly contacts the skin of the user when the wearable device is worn by the user.

The sensor may also be located at a first predetermined position on the wearable device. The first predetermined position is located on the wearable device at a portion where the wearable device can contact the skin of the user when the wearable device is fixed with respect to the user through the frame, and this portion is out of sight of the viewer when the wearable device is fixed with respect to the user through the frame, thus, the sensor is invisible for the viewer. Similarly, the controller and the power supply may also be located at the first determined position to be invisible for the viewer.

Based on the above description, the frame of the wearable device in this embodiment is switchable between the first state and the second state according to the wearing state of the wearable device. In this way, when the wearable device is worn by the user, the frame of the wearable device has a transparency same as the transparency of the transparent window, to allow the frame to be invisible; and when the wearable device is not worn by the user, the frame of the wearable device has a transparency lower than the transparency of the transparent window, to allow the frame to be visible or identifiable.

### Second Embodiment

As shown in FIG. 3, the wearable device in the first embodiment may be a pair of glasses 3, and the frame refers to a frame 31 of the pair of glasses 3, and the transparent window refers to lenses 32 of the pair of glasses 3. Each lens 32 is provided for observing scene from one side to the other side of the lens.

The lens 32 may be colorless and transparent, and when the pair of glasses 3 is worn by the user, the frame 31 is in a first state having a transparency same as the transparency of the lenses 32, and the frame 31 and the lenses 32 are all transparent and colorless, thus are invisible for the viewer. When the pair of glasses 3 is not worn by the user, the frame 31 is in a second state having a transparency lower than the transparency of the lenses 32, thus, the frame 31 is visible or identifiable.

The power supply, the controller and the sensor may be located at a first predetermined position 33. The first predetermined position 33 is located on an inner side of the frame 31 behind the ear of the user where the frame 31 can contact the skin of the user when the pair of glasses 3 is worn by the user, and in this way, the first predetermined position 33 is invisible, thereby allowing the structural component located at the predetermined position 33 to be invisible.

When being worn, the pair of glasses 3 is transparent and invisible, and when not being worn, the pair of glasses 3 is visible or identifiable since the transparency of the frame is decreased.

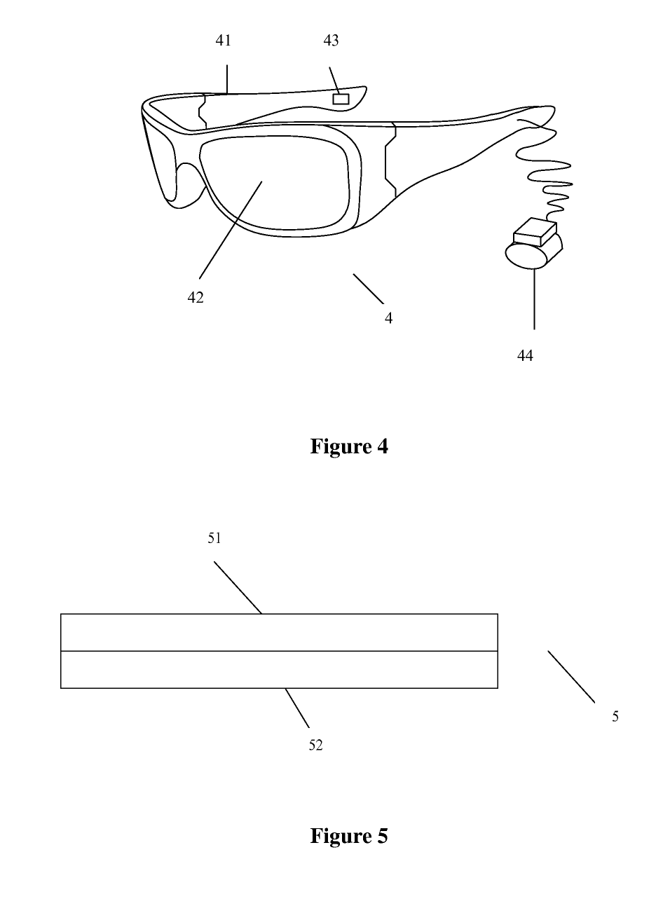

As shown in FIG. 4, the wearable device in the first embodiment may be a pair of intelligent glasses 4. The frame refers to a frame 41 of the pair of intelligent glasses 4, and the transparent window refers to lenses 42 of the pair of intelligent glasses 4. Each lens 42 is a transparent display screen, which may be provided for observing objects at another side of the display screen from one side thereof, and also for displaying set information.

The power supply, the sensor, and the controller of the wearable device may be integrated as a second integral structure 44. The second integral structure 44 may be connected to the frame 41 by a control wire. The power supply, the sensor and the controller, which might affect the transparency of the frame 41, are independent from a first integral device consisting of the frame 41 and the lenses 42, and in this way, the first integral device may be invisible when the wearable device is worn.

In the implementation as shown in FIG. 4, which is similar to the implementation as shown in FIG. 3, one or more of the power supply, the sensor and the controller may be further provided at the first predetermined position 44. Since the pair of intelligent glasses in FIG. 4 is not only required to realize the switching of the frame 41 between the first state and the second state, but also required to display information through the lenses 42, the pair of intelligent glasses has a large power consumption. Preferably, the power supply of the pair of intelligent glasses 4 is independently arranged with respect to the first integral device.

Similarly, the frame 41 of the pair of intelligent glasses 4 is switchable between the first state and the second state according to the wearing state of the wearable device. When being worn, the pair of intelligent glasses is transparent and invisible, and when not being worn, the pair of intelligent glasses is visible or identifiable since the transparency of the frame is decreased.

The wearable device in the first embodiment may be a normal watch. The frame herein refers to a wearing part of the watch, and the transparent window refers to a display window of the watch. When the watch is worn, the wearing part is in the first state to be invisible. When the watch is not worn, the wearing part is in the second state to be visible and identifiable.

The controller, the sensor and the power supply of the wearable device may be arranged at a clasp of the watch. When the watch is worn by a user, the clasp faces the user but is facing away from a viewer, thus in this way, the controller, the sensor and the power supply cannot be seen easily.

Reference is made to FIG. 5. The wearable device in the first embodiment may also be an intelligent watch or an intelligent bracelet 5. The frame refers to a flexible wearing part 52 of the intelligent watch or the intelligent bracelet 5. The transparent window refers to a transparent screen 51 of the intelligent watch or the intelligent bracelet 5.

Similarly, the controller, the sensor and the power supply of the wearable device may be arranged at a clasp of the watch. When the watch is worn by a user, the clasp faces the user but is facing away from a viewer, thus in this way, the controller, the sensor and the power supply cannot be seen easily.

### Third Embodiment

A wearable device is further provided by an embodiment of the present application, which includes a transparent window and a frame. The frame is provided for fixing the transparent window and to fix the wearable device with respect to a user when the user wears the wearable device. The frame has a first state and a second state, the frame in the first state has a transparency same as the transparency of the transparent window, to allow the frame to be invisible, and the frame in the second state has a transparency lower than the transparency of the transparent window, to allow the frame to be visible or identifiable.

The switching of the wearable device between the first state and the second state can be realized through a second integral device matching with the wearable device, and the detail process can be referred to the above embodiments, thus will not be described herein.

When the wearable device is controlled by the second integral device, the frame of the wearable device is switchable between the first state and the second state according to the wearing state. When the wearable device is worn by the user, the frame is controlled to be invisible, and when the wearable device is not worn by the user, the frame is controlled to be visible or identifiable, to facilitate locating the wearable device.

### Four Embodiment

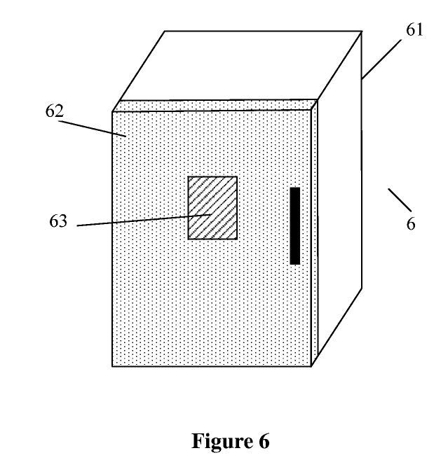

Reference is made to FIG. 6. An electric storage equipment 6 is further provided according to an embodiment of the present application. The electric storage equipment 6 includes a casing 61, a door 62 and a set area 63 with an adjustable transmittance arranged on the casing 61 or the door 62. The set area has a first state and a second state. Light can be transmitted through the set area in the first state, and light cannot be transmitted through the set area in the second state.

The electric storage equipment 6 further includes a sensor and a controller. The sensor is configured to sense whether the set area 63 of the electric storage equipment 6 is triggered, to generate a sensing parameter. The controller is connected to the sensor and is configured to switch the state of the set area 63 according to the sensing parameter. The controller is configured to control the set area to be in the first state when the set area 63 is triggered, to allow an interior of the casing to be visible, and is configured to control the set area to be in the second state when the set area 63 is not triggered, to allow the interior of the casing 61 to be invisible.

In this embodiment, the set area 63 is arranged on the door 62, and the set area may be made of the adjustable transmittance component in the above embodiments. The door 62 may also be entirely made of the adjustable transmittance component in the above embodiments.

The electric storage equipment 6 may generate a sensing parameter by triggering the sensor, and then to control the set area 63 to be in the first state by the controller, thereby allowing the interior of the casing 61 to be visible. In this way, whether a desired object is stored in the electric storage equipment 6 can be determined without opening the door. When the sensor is not triggered, the interior of the casing 61 is not visible, thereby avoiding the objects in the casing being observed.

When the electric storage equipment 6 is a refrigerator or a freezer, whether a desired object is stored inside the electric storage equipment 6 can be determined without opening the door 62, which avoids unnecessarily opening the door when there is no desired object in the casing 61, and at the same time, avoiding power consumption due to the unnecessary opening action.

In order to clearly show the environment inside the casing 61 when the set area 63 is in the first state, the electric storage equipment 6 is further provided with a lighting device arranged inside the casing. The controller is further configured to activate the lighting device when the set area is in the first state and deactivate the lighting device when the set area is in the second state.

The electric storage equipment according to the present application includes a casing and a door, and the electric storage equipment further includes a set area with an adjustable transmittance arranged on the casing or the door, and the set area has a first state and a second state, and in a case that the set area is in the first state, light is allowed to be transmitted through the set area, and in a case that the set area is in the second state, light is prevented from being transmitted through the set area; a sensor, which is configured to sense whether the set area of the electric storage equipment is triggered, to generate a sensing parameter; a controller, which is connected to the sensor and configured to switch the state of the set area according to the sensing parameter, and the controller is configured to control the set area to be in the first state in a case that the set area is triggered, to allow an interior of the casing to be visible; and the controller is configured to control the set area to be in the second state in a case that the set area is not triggered, to allow the interior of the casing to be invisible. The set area has two transmittance states. When the set area is in the first state, light can be transmitted through the set area, thus, objects in the casing can be observed without opening the door, which is convenient to determine whether a desired object is inside the casing, and the user can open the door when it is determined that the desired object is inside the casing. If the set area is in the second state, light cannot be transmitted through the set area, thus, objects in the casing cannot be seen

It is to be noted that, in the embodiment of the present application, the sensor may be triggered in a contact manner or a non-contact manner, for example, the sensor may be a sensing electrode, the sensor can be triggered when the distance between the skin of the user and the sensing electrode is smaller than a predetermined distance. In the embodiments of the present application, the connection may a wire connection or a wireless connection.

Based on the above description of the disclosed embodiments, the person skilled in the art is capable of carrying out or using the present application. It is obvious for the person skilled in the art to make many modifications to these embodiments. The general principle defined herein may be realized in other embodiments without departing from the scope of the present application. Therefore, the present application is not limited to the embodiments illustrated herein, but should be defined by the broadest scope consistent with the principle and novel features disclosed herein.

What is claimed is:

1. A wearable device, comprising:
a frame, configured to fix the wearable device with respect to a user in a case that the wearable device is worn by the user, and the frame has a first state having a first transparency and a second state having a second transparency lower than the first transparency;
a sensor configured to sense a wearing state of the wearable device to generate a wearing state sensing parameter; and
a controller, which is connected to the sensor and is configured to control the frame to be in the first state or in the second state according to the wearing state sensing parameter.

2. The wearable device according to claim 1, wherein, the wearable device further comprises a transparent window, the frame is configured to fix the transparent window, and the first transparency of the frame in the first state is same as a transparency of the transparent window, and the second transparency of the frame in the second state is lower than the transparency of the transparent window; and
the controller is configured to determine whether the wearable device is worn by the user according to the wearing state sensing parameter; and in a case that the controller determines, according to the wearing state sensing parameter, that the wearable device is fixed with respect to the user through the frame, the controller is configured to control the frame to be in the first state, to allow the frame to be invisible; and in a case that the controller determines that the wearable device is not worn by the user according to the wearing state sensing parameter, the controller is configured to control the frame to be in the second state, to allow the frame to be visible or identifiable.

3. The wearable device according to claim 1, wherein, the frame is an adjustable transmittance component, which comprises a media layer; and
the controller is configured to vary the direction of M molecules of the media layer, and the controller is configured to control the M molecules to be arranged in a first direction to form a light passage, to allow the frame to be in the first state, and is configured to control the M molecules to be arranged in a second direction, which is different from the first direction, to shut off the light passage, to allow the frame to be in the second state.

4. The wearable device according to claim 2, wherein, in a case that the wearable device is fixed with respect to the user by the frame, a first beam is transmitted to the skin of the user from an outer side of the frame through a first light passage of the light passage; and the first beam is scattered diffusely by the skin of the user to form a second light beam, and the second light beam is transmitted to the outer side of the frame from an inner side of the frame through a second light passage of the light passage.

5. The wearable device according to claim 3, wherein, the adjustable transmittance component further comprises:
a first transparent polar plate and a second transparent polar plate which are arranged opposite to each other; and
the media layer is arranged between the first transparent polar plate and the second transparent polar plate; and
the controller is configured to vary the direction of M molecules of the media layer, and the controller is configured to control the M molecules to be arranged in the first direction to form a light passage, to allow the frame to be in the first state; and is configured to control the M molecules to be arranged in the second direction, which is different from the first direction, to shut off the light passage, to allow the frame to be in the second state.

6. The wearable device according to claim 2, wherein, the frame is an adjustable transmittance component, which comprises a media layer; and
the controller is configured to vary the direction of M molecules of the media layer, and the controller is configured to control the M molecules to be arranged in a first direction to form a light passage, to allow the frame to be in the first state, and is configured to control the M molecules to be arranged in a second direction, which is different from the first direction, to shut off the light passage, to allow the frame to be in the second state.

7. The wearable device according to claim 6, wherein, in a case that the wearable device is fixed with respect to the user by the frame, a first beam is transmitted to the skin of the user from an outer side of the frame through a first light passage of the light passage; and the first beam is scattered diffusely by the skin of the user to form a second light beam, and the second light beam is transmitted to the outer side of the frame from an inner side of the frame through a second light passage of the light passage.

8. The wearable device according to claim 7, wherein, the adjustable transmittance component further comprises:
a first transparent polar plate and a second transparent polar plate which are arranged opposite to each other; and
the media layer is arranged between the first transparent polar plate and the second transparent polar plate; and
the controller is configured to vary the direction of M molecules of the media layer, and the controller is configured to control the M molecules to be arranged in the first direction to form a light passage, to allow the frame to be in the first state; and is configured to control the M molecules to be arranged in the second direction, which is different from the first direction, to shut off the light passage, to allow the frame to be in the second state.

9. The wearable device according to claim 2, further comprising a power supply; wherein the transparent window and the frame are defined as a first integral device; and
the power supply is an independent structural component separably connected to the first integral device; the sensor is an independent structural component separably connected to the first integral device; and the controller is an independent structural component separably connected to the first integral device.

10. The wearable device according to claim 9, wherein, the power supply, the sensor and the controller form a second integral device, and the second integral device is an independent structural component separably connected to the first integral device.

11. The wearable device according to claim 1, wherein, the sensor is arranged at a first predetermined position on the wearable device, the first predetermined position is located on the wearable device at a portion where the wearable device is in contact with the skin of the user in a case that the wearable device is fixed with respect to the user through the frame, and this portion is out of sight of a viewer in a case that the wearable device is fixed with respect to the user through the frame.

12. The wearable device according to claim 2, wherein, the sensor is arranged at a first predetermined position on the wearable device, the first predetermined position is located on the wearable device at a portion where the wearable device is in contact with the skin of the user in a case that the wearable device is fixed with respect to the user through the frame, and this portion is out of sight of a viewer in a case that the wearable device is fixed with respect to the user through the frame.

13. A wearable device, comprising:
a transparent window; and
a frame, which is configured to fix the transparent window and configured to fix the wearable device with respect to a user in a case that the wearable device is worn by the user, and the frame has a first state and a second state, the frame in the first state is configured to have a transparency same as a transparency of the transparent window, to allow the frame to be invisible, and the frame in the second state is configured to have a transparency lower than the transparency of the transparent window, to allow the frame to be visible or identifiable.

14. An electric storage equipment, comprising:
a set area with an adjustable transmittance, and the set area has a first state having a first transmittance and a second state having a second transmittance different from the first transmittance;
a sensor, which is configured to sense whether the set area of the electric storage equipment is triggered, to generate a sensing parameter; and
a controller, which is connected to the sensor and configured to switch the state of the set area according to the sensing parameter to adjust visibility of a space at least partially shielded by the set area.

15. The electric storage equipment according to claim 14, wherein, in a case that the set area is in the first state, light is allowed to be transmitted through the set area, and in a case that the set area is in the second state, light is prevented from being transmitted through the set area; and the controller is configured to control the set area to be in the first state in a case that the set area is triggered, to allow an interior of the casing to be visible; and the controller is configured to control the set area to be in the second state in a case that the set area is not triggered, to allow the interior of the casing to be invisible.

16. The electric storage equipment according to claim 14, wherein, the electric storage equipment comprises a casing and a door, and the set area is arranged on the casing or the door.

17. The electric storage equipment according to claim 16, further comprising a lighting device arranged in the casing; wherein,
the controller is further configured to activate the lighting device in a case that the set area is in the first state and deactivate the lighting device in a case that the set area is in the second state.

18. The electric storage equipment according to claim 15, wherein, the electric storage equipment comprises a casing and a door, and the set area is arranged on the casing or the door.

19. The electric storage equipment according to claim 18, further comprising a lighting device arranged in the casing; wherein,
the controller is further configured to activate the lighting device in a case that the set area is in the first state and deactivate the lighting device in a case that the set area is in the second state.
